(19) United States
(12) Patent Application Publication
(10) Pub. No.: US 2008/0158660 A1
(43) Pub. Date: Jul. 3, 2008

(54) Optical Processing Apparatus

(75) Inventors: Antonella Bogoni, Mantova (IT); Luca Poti, Pisa (IT); Mirco Scaffardi, Parma (IT)

Correspondence Address: COATS & BENNETT, PLLC, 1400 Crescent Green, Suite 300, Cary, NC, 27518, US

(73) Assignee: ERICSSON AB, Stockholm (SE)

(21) Appl. No.: 11/876,186

(22) Filed: Oct. 22, 2007

(30) Foreign Application Priority Data
Dec. 28, 2006 (EP) PCT/EP05/12576

(51) Int. Cl. H01S 3/00

(52) U.S. Cl. 359/344

(57) ABSTRACT

An optical 1-bit comparator has at least two inputs for receiving a respective first input signal A and a second input signal B, each comprising a single bit word, and at least three outputs, each of the three outputs providing a respective solution to the logical expressions: A>B, A<B and A=B, characterised in that each logical expression is obtained using at least one semiconductor optical amplifier (SOA) capable of providing cross gain modulation. Preferably the complete circuit requires only 3 identical SOAs to provide the three logical outputs, each operating with cross gain modulation.

### RELATED APPLICATIONS

This application claims priority from foreign application PCT/EP2006/012576 filed on Dec. 28, 2006. That application is incorporated herein by reference in its entirety.

### FIELD OF THE INVENTION

This invention relates to the realization of an optical processing apparatus, and in particular to an optical apparatus which performs a bit comparison.

### BACKGROUND OF THE INVENTION

In recent years advances in computing power have lead to processors which include more and more logical elements. The speed of these devices is limited by the size of the elements, since it takes time for an electrical signal to propagate through the processor. This speed can be increased by making things smaller, reducing the path lengths. However, many people believe that the technology is reaching its limit and that it may be difficult to make further gains through miniaturisation.

All-optical processing has been deeply investigated as an alternative approach for implementing fast processors. They have found particular application in communication systems because they can operate at much higher speeds than conventional electronic devices. Moreover a research effort is going on for applying all-optical processing to other general computing roles. For instance an all-optical subsystem for the comparison of Boolean numbers can find application in optical computing as well as in all-optical packet switched networks for the checking of the packets address and the evaluation of the priority between packets.

An object of the present invention is to provide an optical processing apparatus which is suitable for comparing bits exploiting a number of logical operations, such as may be used as a building block in an optical processor.

### SUMMARY OF THE INVENTION

According to a first aspect the invention provides an optical 1-bit comparator having at least two inputs for receiving a respective first input signal A and a second input signal B, each comprising a single bit word, and at least three outputs, each of the three outputs providing a respective solution to the logical expressions: A>B, A<B and A=B, characterised in that each logical expression is obtained using at least one semiconductor optical amplifier (SOA) capable of providing cross gain modulation.

Preferably each amplifier receives at one end one of the following signals: signal A or signal B or the signal output from one or more of the other logical expressions or a signal derived from any of the preceding signals. Each amplifier may also receive at its other end one or more of the following signals: signal A or signal B or the output from one or more of the other logical expressions or a signal derived from any of the preceding signals. The signals may of course be amplified, attenuated or delayed before being applied to the amplifier.

The optical processing apparatus may comprise three switched optical amplifiers. Thus each logical expression may be derived using only a single semiconductor optical amplifier. They may be identical and they may be fabricated in a single integrated package. This provides considerable cost and packaging benefits.

Each SOA may therefore be used to perform a single one of the three logical function and may employ cross gain modulation. In this case each amplifier receives two inputs, with one input being used as an optical pump for the amplifier to modulate the other input.

Preferably the 3 logical functions comprise: notB and A, notA and B and NorA and B (equal to A=B). The first two are equivalent to A<B and A>B. These may be fed to the third SOA after both passing through an OR gate. The third amplifier may be pumped by a clocked pulse signal matched in phase to the input words A and B. The OR gate may be conveniently embodied as a fibre splitter. The output of the third amplifier will therefore provide the third function A=B.

The first two logical functions may be implemented only by a single SOA. The last may be implemented by a single OA in series with a fibre couple that receives the output from the first two as its inputs. The coupler receives two inputs and passes them to its output to provide an OR function.

In the case of the first logical function (notB AND A) the signal B may be used as a pump to modulate the gain of the SOA, while the signal A is applied to the input of the amplifier and thus experiences high or low gain depending on the value of B. Thus, if B=1 the SOA is saturated and the output signal is 0 since low gain is applied to the input signal A, while if B=0 the output is 1 only if A=1 as a high gain is applied to signal A. The power of B should be high enough to saturate the SOA gain, while A may be attenuated in order to avoid SOA saturation.

The same principle may be applied to implement the second logical function (B AND notA). In this case A acts as a pump rather than B, while B is the signal fed to the input of the SOA which experiences gain modulation. In this case the power of B is set low. The counter-propagating configuration in polarisation independent SOAs makes the scheme wavelength independent and polarisation insensitive.

The NOR between A>B and A<B can be replaced with an OR, giving the function not(A=B), followed by a NOT. The OR gives the function not(A=B), in fact the output value is 1 only if A and B are different (A>B or A<B is 1). Since A>B and A<B can not be 1 at the same time, the OR can be implemented by means of a fibre coupler. The NOT is obtained exploiting XGM between not(A=B) and a pulse train probe at same wavelength.

In all three cases, the amplitude of the pump signal applied to the amplifier should be chosen to be sufficient as to induce cross gain modulation within the amplifier.

It will be understood that one or more of the three output functions may be rejected to provide an apparatus which gives only a single logical expression as its output. For example, only the A=B output need be kept, or the expressions A>B, A=B need be kept. Protection for such an apparatus is also sought through this application. Of course, having all three is preferred as it gives the maximum utility from the apparatus, allowing a designer of a circuit to chose which of the three outputs to utilise.

One or more optical delay lines may be provided in the apparatus whose purpose is to ensure that all the signals propagate through the amplifiers at the correct times. i.e. so that all the amplifiers receive the signals at overlapping times. The time delays will therefore be chosen according to the topology of the apparatus used.

One or more attenuators may also be provided which are adapted to optimise the amplitude of the signals used at each input to the amplifiers (be it a signal to be amplified or a signal acting as a pump).

According to a second aspect the invention provides an optical communications network including at least one comparator according to the first aspect of the invention.

### BRIEF DESCRIPTION OF THE DRAWINGS

There will now be described, by way of example only, one embodiment of the present invention with reference to and as illustrated in the accompanying drawings of which:

FIG. 1(a) is an overview of a set of logical functions that convert two input signals A and B into three logical output signals;

FIG. 1(b) is an embodiment of the functions in an entirely optical domain which falls within the first aspect of the invention;

FIG. 2 illustrates an experimental set up designed to prove the embodiment of FIG. 1(b) in a laboratory;

FIG. 3 shows the input and output eye diagrams (left) and sequences (right) for a experimental arrangement of the embodiment of FIG. 2; and

FIG. 4 illustrates the performance of the experimental arrangement exploiting Bit error rate (BER) measurements on the output signals

### DESCRIPTION OF AN EMBODIMENT OF THE INVENTION

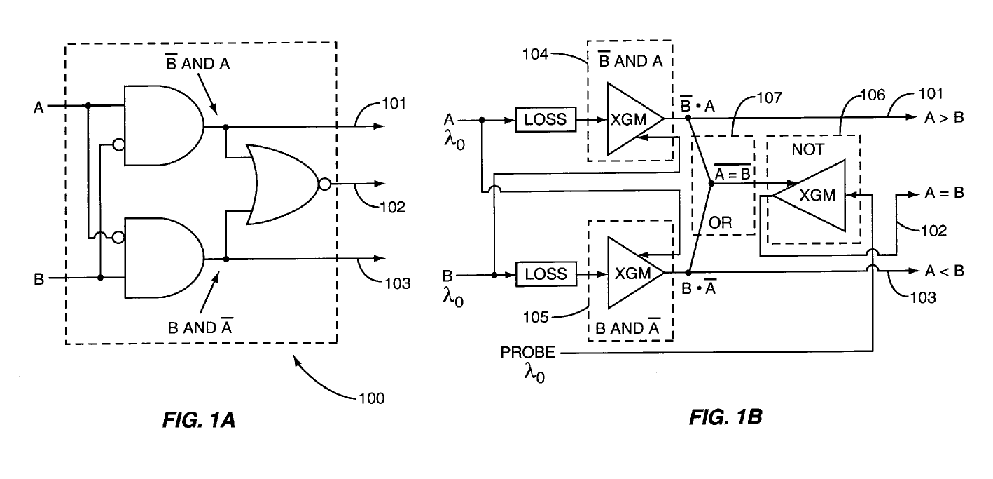

FIG. 1(a) of the accompanying drawings is an overview of a 1-bit comparator 100 in the form of a combinatorial network able to compare two words A and B with length of one bit, giving at the output three logical functions 101,102,103 which give A>B, A<B and A=B (each output is 1 if the condition is satisfied, 0 otherwise). These three logical functions 101,102,103 can be implemented with the logical circuit shown in FIG. 1 (a). The function A>B is equivalent to the AND between notB and A: the output is 1 only if B is 0 and A is 1. In a similar way, the function A<B is obtained with the AND between B and notA. The NOR between A>B and A<B gives the function A=B.

The logical circuit represented in FIG. 1 (a) of the accompanying drawings can be implemented entirely optically with the physical schematic set-up shown in FIG. 1 (b) of the accompanying drawings. This represents an embodiment of an optical apparatus that falls within the scope of the present invention. One of skill in the art will, however, appreciate that this is not intended to be limiting to the scope of invention and various modifications and substitutions can be made.

The functions (notB AND A) and (B AND notA) are implemented exploiting Cross Gain Modulation (XGM) in a respective single semiconductor optical amplifier (SOA) 104,105,106.

In the case of the function (notB AND A) the signal B modulates the SOA gain, while A experiences high or low gain depending on the value of B: if B=1 the SOA is saturated and the output signal is 0, while if B=0 the output is 1 only if A=1. The power of B should be high enough to saturate the SOA gain, while A is attenuated in order to avoid SOA saturation.

The same principle is applied to implement the function (B AND notA). In this case A acts as a pump, while B is a signal experiencing gain modulation. In this case the power of B is set low. The counter-propagating configuration in polarisation independent SOAs makes the scheme wavelength independent and polarisation insensitive.

The NOR between A>B and A<B can be replaced with an OR, giving the function not(A=B), followed by a NOT. The OR gives the function not(A=B), in fact the output value is 1 only if A and B are different (A>B or A<B is 1). Since A>B and A<B can not be 1 at the same time, the OR can be implemented by means of a fibre coupler 107. The NOT is obtained exploiting XGM between the input and a pulse train probe at same wavelength.

2. Experimental Setup and Results

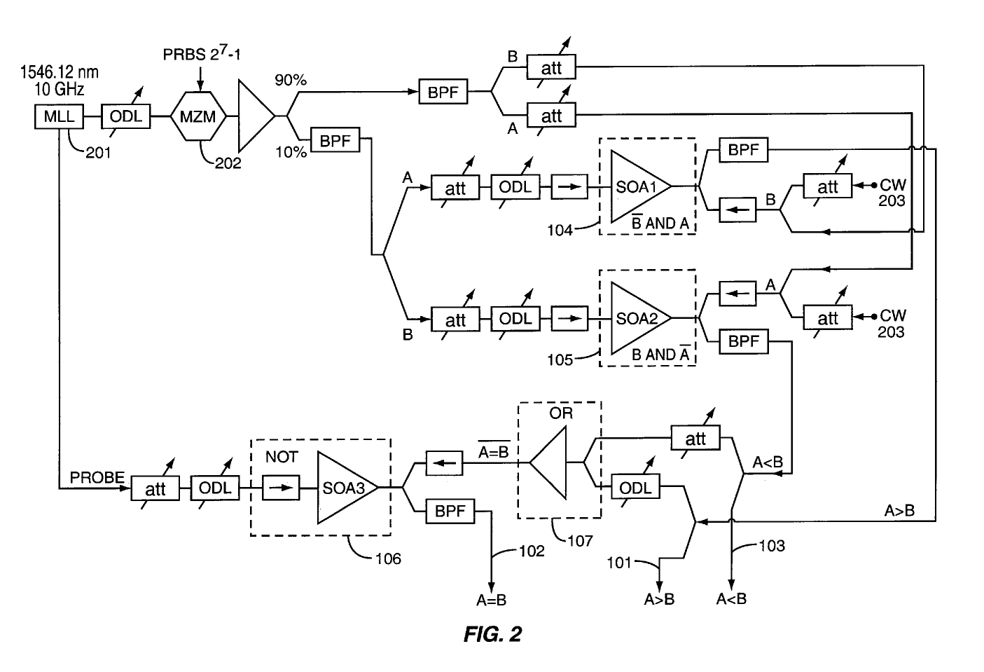

To prove the invention an experimental set-up was constructed as shown in FIG. 2 of the accompanying drawings. The input words A and B are generated by splitting and opportunely delaying a mode locked laser (MLL 201) at 1546.12 nm (10 GHz repetition rate) modulated with a PRBS 2⁷−1 202. The power of the signals inducing gain modulation is ˜11 dBm at each SOAs input, while the power of the signal experiencing gain modulation is −16 dBm at input of SOA1, while it is −5 dBm at input of SOA2 and SOA3.

An optional counter-propagating continuous wave (CW) 203—in this case of 10 dB—is used to reduce the SOA recovering time, limiting the pattern effect. Note that in this case we used different discrete SOAs, with optical gain in the range 18-25 dB, saturation output power in the range 6-14 dBm, and noise figure in the range 8-10 dB. The signals are synchronised by a proper design of the optical paths length and by means of tunable delay lines (ODL). Signals equalisation is obtained by means of variable optical attenuators (att.).

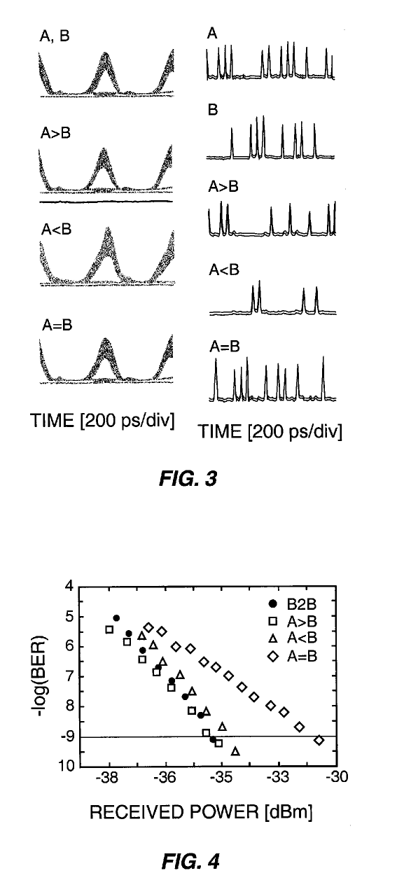

FIG. 3 of the accompanying drawings shows the input and output eye diagrams (left) and sequences (right). The eye diagrams look clean and the sequences show the bit comparator works properly. Most of the output pattern effect is due to the not perfect equalisation of the input signals. The contrast ratio is higher than 7.1, 8.1 and 7.8 dB for the signals A>B, A<B and A=B respectively.

The performances of the 1-bit comparator were also investigated exploiting bit error rate (BER) measurements at 10 Gb/s on the output signals as shown in FIG. 4 of the accompanying drawings. The measurements are achieved with a pre-amplified receiver. Error-free performances are obtained for all the output signals. At a BER=10 −9 a power penalty with respect the back-to-back of 0 and 0.3 dB is obtained for A>B and A<B respectively. The signal A=B has a penalty of about 3 dB. The higher penalty is induced by the high self phase modulation (SPM)-induced spectral broadening in SOA3, which increases the in-band noise power after filtering. A performance improvement can be obtained using opportune SOAs with optimised specifications. Moreover the proposed scheme can be fully integrated with strong advantages in terms of power consumption, stability, and cost.

For the avoidance of doubt, one of skill in the art will appreciate that the terms notA and notB refer to the logical inverse of A and B respectively. For example, if A=1, notA=0 and if A=0 notA=1.

The present invention may, of course, be carried out in other ways than those specifically set forth herein without departing from essential characteristics of the invention. Therefore, the present embodiments are to be considered in all respects as illustrative and not restrictive, and all changes coming within the meaning and equivalency range of the appended claims are intended to be embraced therein.

What is claimed is:

1. An optical 1-bit comparator comprising:
a first input configured to receive a first input signal A comprising a single bit word;
a second input configured to receive a second input signal B comprising a single bit word;
at least one semiconductor optical amplifier (SOA) configured to provide cross gain modulation; and
a logic circuit configured to:
process the first and second input signals A, B;
output a first output signal implementing the comparison A>B;
output a second output signal implementing the comparison A<B; and
output a third output signal to implementing the comparison A=B.

2. The optical comparator of claim 1 wherein the at least one SOA comprises:
a first SOA configured to output the first output signal;
a second SOA configured to output the second output signal; and
a third SOA configured to output the third output signal.

3. The optical comparator of claim 2 wherein each of the first, second, and third SOAs comprise:
a first end configured to receive at least one of the first input signal A, the second input signal B, and at least one of the first, second, and third output signals; and
a second end configured to receive at least one of the first input signal A, second input signal B, and at least one of the first, second, and third output signals.

4. The optical comparator of claim 1 wherein the at least one SOA comprises a first SOA, a second SOA, and a third SOA, and wherein only a single one of the first, second, and third SOAs outputs each of the first, second, and third output signals.

5. The optical comparator of claim 4 wherein each of the first, second, and third SOAs are identical.

6. The optical comparator of claim 1 wherein the at least one SOA comprises an SOA receiving an OR function implemented on the first and second output signals as an input.

7. The optical comparator of claim 6 wherein the OR function is implemented by a fiber splitter.

8. the optical comparator of claim 1 wherein the first output signal is produced by feeding the second input signal B as a pump signal to modulate the gain of a first SOA and the first input signal A is applied to a first end of the first SOA whereby the first SOA experiences high or low gain depending on a value of the second input signal B.

9. The optical comparator of claim 1 wherein the second output signal is produced by feeding the first input signal A as a pump signal to modulate the gain of a second SOA and the first input signal B is fed to a first end of the second SOA whereby the second SOA experiences high or low gain depending on a value of the first input signal A.

10. The optical comparator of claim 1 further comprising at least one optical delay line configured to ensure that signals propagate through all of the SOAs at overlapping times.

11. The optical comparator of claim 1 further comprising at least one attenuator configured to optimize an amplitude of the first and second input signals.

12. A method of performing bit comparisons in an optical comparator, the method comprising:
receiving a first input signal A comprising a single bit word at a first input;
receiving a second input signal B comprising a single bit word at a second input;
processing the first and second input signals A, B at a logic circuit;
outputting a first output signal implementing the comparison A>B;
outputting a second output signal implementing the comparison A<B; and
output a third output signal implementing the comparison A=B.

13. The method of claim 12 wherein:
a first SOA is configured to output the first output signal;
a second SOA is configured to output the second output signal; and
a third SOA is configured to output the third output signal.

14. The method of claim 13 further comprising:
receiving at least one of the first input signal A, the second input signal B, and at least one of the first, second, and third output signals at a first end of each of the first, second, and third SOAs; and
receiving at least one of the first input signal A, the second input signal B, and at least one of the first, second, and third output signals at a second end of each of the first, second, and third SOAs.

15. The method of claim 12 wherein outputting the first, second, and third output signals comprises outputting the first, second, and third output signals using a single SOA.

16. The method of claim 12 further comprising implementing an OR function on the first and second output signals, and receiving the result as an input at an SOA.

17. The method of claim 16 wherein implementing an OR function on the first and second output signals comprises implementing the OR function using a fiber splitter.

18. The method of claim 12 wherein outputting the first output signal comprises feeding the second input signal B as a pump signal to modulate the gain of a first SOA and applying the first input signal A to a first end of a first SOA, such that the first SOA experiences high or low gain depending on a value of the second input signal B.

19. The method of claim 12 wherein outputting the second output signal comprises feeding the first input signal A as a pump signal to modulate the gain of a second SOA and applying the second input signal B to a first end of the second SOA, such that the second SOA experiences high or low gain depending on a value of the first input signal A.

20. The method of claim 12 wherein the optical comparator comprises a plurality of SOAs, and wherein the method further comprises delaying the first and second input signals A, B to ensure that signals propagate through all of the SOAs at overlapping times.

21. The method of claim 12 further comprising attenuating the first and second input signals A, B applied at each input of one or more SOAs in the optical comparator to optimize an amplitude of the first and second input signals.
